(19) United States
(12) Patent Application Publication
(10) Pub. No.: US 2018/0010616 A1
(43) Pub. Date: Jan. 11, 2018

(54) STRUT ASSEMBLY FOR AN AIRCRAFT ENGINE

(71) Applicant: General Electric Company, Schenectady, NY (US)

(72) Inventors: Daniel Elmer King, Norwood, OH (US); Kenneth E. Seitzer, Cincinnati, OH (US); Christopher Timothy Roll, West Chester, OH (US)

(21) Appl. No.: 15/201,934

(22) Filed: Jul. 5, 2016

(51) Int. Cl. F04D 29/52; B64D 27/10; F02K 3/06; F04D 29/02; F02C 3/04

(52) U.S. Cl. CPC F04D 29/522; F04D 29/023; F02C 3/04; F02K 3/06; B64D 27/10; F05D 2220/323; F05D 2240/35; F05D 2300/603

(57) ABSTRACT

A strut assembly for a gas turbine engine includes an outer structural case. The outer structural case includes a first mounting pad for mounting a first strut and a second mounting pad for mounting a second strut. The outer structural case further includes a case ligament extending between the first mounting pad and the second mounting pad in a substantially straight direction to reduce an amount of bending stress on the outer structural case.

### FEDERALLY SPONSORED RESEARCH

This invention was made with government support under contract number FA8650-09-D-2922 of the U.S. Air Force. The government may have certain rights in the invention.

### FIELD OF THE INVENTION

The present subject matter relates generally to a strut assembly for an aircraft engine.

### BACKGROUND OF THE INVENTION

A gas turbine engine includes a fan section and a core engine. The core engine includes serial axial flow relationship, a high pressure compressor to compress an airflow entering the core engine, a combustor in which a mixture of fuel and the compressed air is burned to generate a propulsive gas flow, and a high pressure turbine which is rotated by the propulsive gas flow and which is connected by a shaft to drive the high pressure compressor. A typical bypass turbofan engine adds a low pressure turbine aft of the high pressure turbine which drives a fan of the fan section located forward of the high pressure compressor. A splitter aft of the fan divides fan flow exiting the fan into core engine flow and bypass flow around the core engine.

The fan section includes one or more stages of fan rotor blades and a strut assembly. The strut assembly includes circumferentially spaced struts mounted to a hub at radially inner ends and to an outer case at radially outer ends. The outer case defines a circular shape, such that a circular flowpath surface is defined for a flowpath through the fan section. The case is typically circular in nature in order to withstand relatively high internal pressures. A circular case is known to be well-suited for withstanding these relatively high internal pressures (e.g., a delta pressure load of at least about fifty pounds per square inch).

The strut assembly must be capable of withstanding relatively large forces generated during operation of the gas turbine engine. These forces may include static forces from a weight of the various components of the gas turbine engine, as well as static forces generated during, e.g., in certain maneuvers of an aircraft including the gas turbine engine. Additionally, the strut assembly may be exposed to dynamic forced during, e.g., a fan blade out event, in which case a resulting asymmetrically balanced fan subjects the strut assembly to relatively large dynamic loads. The strut assembly is typically formed in a relatively robust manner in order to withstand the static and dynamic forces. However, such may lead to a relatively heavy strut assembly for the gas turbine engine.

Accordingly, a strut assembly better able to withstand the static and dynamic forces would be useful. Moreover, a strut assembly better able to withstand the static and dynamic forces, while reducing an overall weight of the strut assembly, would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a strut assembly is provided for a gas turbine engine. The strut assembly includes an outer structural case. The outer structural case includes a first mounting pad for mounting a first strut, a second mounting pad for mounting a second strut, and a case ligament. The case ligament extends between the first mounting pad and the second mounting pad, the case ligament extending in a substantially straight direction from the first mounting pad to the second mounting pad.

In another exemplary embodiment of the present disclosure, a strut assembly is provided for a gas turbine engine defining a circumferential direction. The strut assembly includes a plurality of struts and an outer structural case. The outer structural case includes a plurality of mounting pads spaced generally along the circumferential direction, each mounting pad having a strut of the plurality of struts mounted thereto. The outer structural case additionally includes a plurality of case ligaments extending between adjacent mounting pads, each case ligament extending in a substantially straight direction between adjacent mounting pads.

In yet another exemplary embodiment of the present disclosure, a gas turbine engine is provided. The gas turbine engine includes a core turbine engine and a fan section in flow communication with the core turbine engine. The fan section includes a strut assembly having an outer structural case. The outer structural case includes a first mounting pad for mounting a first strut, a second mounting pad for mounting a second strut, and a case ligament. The case ligament extends between the first mounting pad and the second mounting pad, the case ligament extending in a substantially straight direction from the first mounting pad to the second mounting pad.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a close-up, schematic, cross-sectional view of a forward strut assembly of the exemplary gas turbine engine of FIG. 1.

FIG. 3 is an isolated, axial view of the exemplary forward strut assembly of FIG. 2.

FIG. 4 is a close-up, isometric view of an outer structural frame of the exemplary strut assembly of FIG. 3.

FIG. 5 is another close-up view of the exemplary strut assembly of FIG. 3 depicting a strut attached to an outer structural case in accordance with an exemplary aspect of the present disclosure.

FIG. 6 is a close-up, isometric view of an outer structural frame of a strut assembly in accordance with another exemplary embodiment.

FIG. 7 is a close-up, cross-sectional view of the exemplary strut assembly of FIG. 6.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

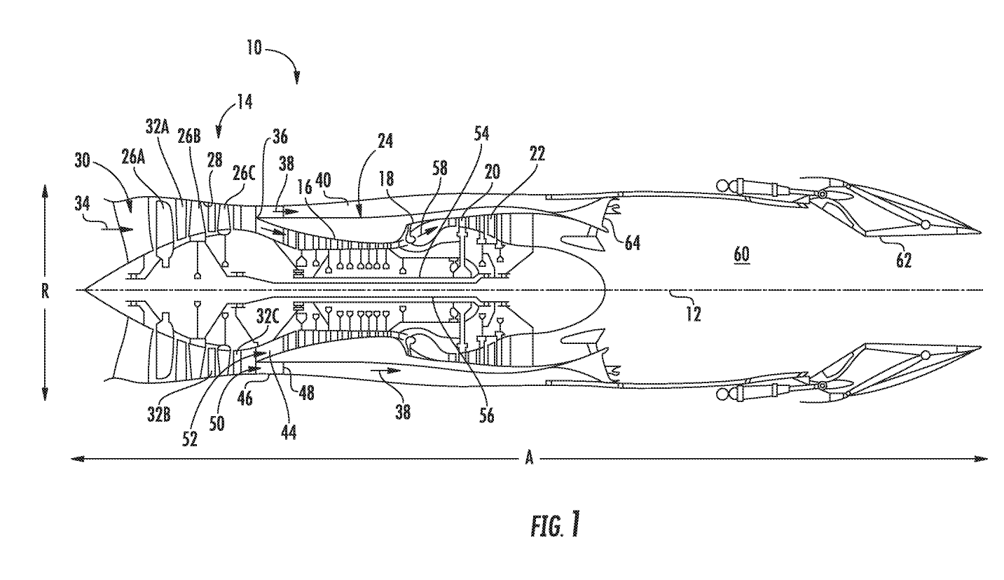

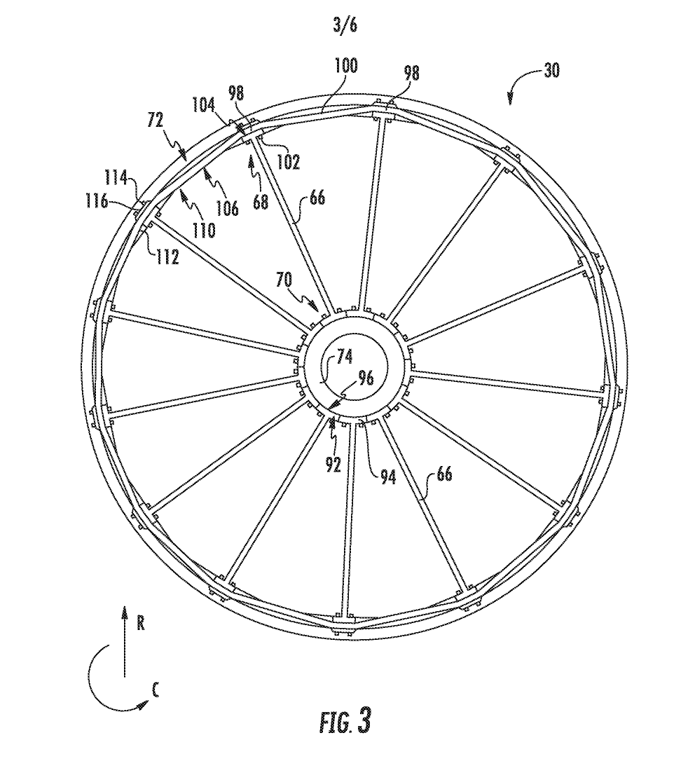

FIG. 1 is a schematic representation of an aircraft gas turbine engine 10 in accordance with one embodiment of the present disclosure. The gas turbine engine 10 defines an axial direction A, a radial direction R, and a circumferential direction C (i.e., a direction extending about the axial direction A, see FIG. 3). The gas turbine engine 10 includes an engine centerline 12 extending along the axial direction A depicted in phantom for reference and has, in serial flow relationship, a fan section 14, a high pressure compressor 16, a combustion section 18, a high pressure turbine 20, and a low pressure turbine 22. The high pressure compressor 16, the combustion section 18 and high pressure turbine 20 are often referred to as a core engine 24.

The fan section 14 is illustrated as a multi-stage fan section having first, second, and third stage fan blades 26A, 26B, and 26C, respectively, disposed within an annular fan duct 28. The fan section 14 additionally includes a strut assembly supporting at least in part the fan section 14. Specifically, for the embodiment depicted, the fan section 14 includes a forward strut assembly 30 located forward of the first stage fan blades 26A. Additionally, disposed adjacent to each of the first, second, and third stage fan blades 26A, 26B, and 26C, the fan section 14 includes stages of guide vanes. Specifically, the exemplary fan section 14 depicted includes first stage guide vanes 32A located aft of the first stage fan blades 26A, second stage guide vanes 32B located aft of the second stage fan blades 26B, and third stage guide vanes 32C located aft of the third stage fan blades 26C. The first, second, and third stage guide vanes 32A, 32B, 32C are each disposed around the engine centerline 12, along the circumferential direction C. In certain embodiments, the third stage guide vanes 32C may further be configured as struts.

Fan air 34 exits the fan section 14 and an annular splitter 36 splits the fan air 34 into a bypass air portion 38 bypassed around the core engine 24 through a bypass duct 40 and into a core engine air portion 42 passed through a diffusion duct 44 into the core engine 24. At the aft end of the fan section 14 is a fan frame 46 including a circumferentially disposed plurality of structural struts 48. The struts 48 extend radially across a fan bypass inlet 50 of the bypass duct 40 and a core engine inlet 52 of diffusion duct 44. The splitter 36 is sectioned and attached to the struts 48 and splitter 36 extends axially between the fan bypass inlet 50 and the core engine inlet 52.

Within the core engine 24, a high pressure rotor shaft 54 connects, in driving relationship, the high pressure turbine 20 to the high pressure compressor 16 and a low pressure rotor shaft 56 drivingly connects the low pressure turbine 22 to the fan section 14. Fuel is burned in the combustion section 18 producing a hot gas flow 58 which is directed through the high pressure and low pressure turbines 20 and 22, respectively, to power the engine 10. The hot gas flow 58 is discharged into an exhaust section 60 of the engine 10 where it is mixed with the bypass air portion 38 from the bypass duct 40 and exhausted through a variable nozzle 62 at the aft end of the engine 10. An afterburner 64 may be used for thrust augmentation. The exemplary engine 10 illustrated in FIG. 1 is typical of a military gas turbine aircraft engine 10, such as the General Electric F-110.

It should be appreciated, however, that the exemplary gas turbine engine 10 depicted in FIG. 1 is provided by way of example only, and in other embodiments of the present disclosure, the gas turbine engine 10 may have any other suitable form or configuration. For example, in other exemplary embodiments, the gas turbine engine 10 may additionally include a low pressure compressor forward of the HP compressor 16 and aft of the fan section 14. Further, in still other embodiments, the gas turbine engine may instead be configured as any other suitable turbofan engine, a turboshaft engine, a turboprop engine, etc.

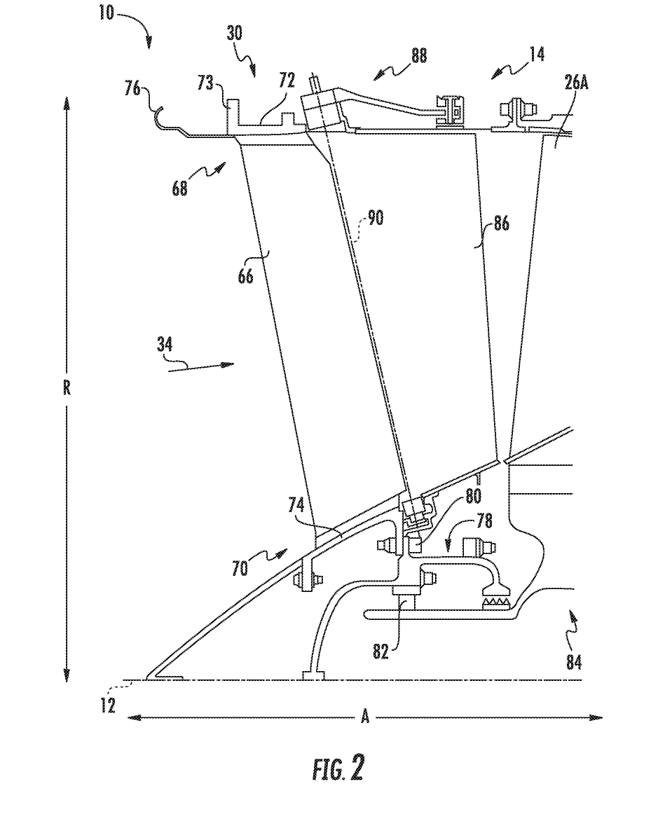

Referring now to FIGS. 2 and 3, views are provided of the fan section 14, or more particularly, of the forward strut assembly 30 of the fan section 14 of the exemplary engine 10 of FIG. 1. Specifically, FIG. 2 provides a close-up, side, cross-sectional view of the forward strut assembly 30 of the exemplary fan section 14 depicted in FIG. 1 installed in the engine 10, and FIG. 3 provides an isolated, axial view of the forward strut assembly 30 of the exemplary fan section 14 depicted in FIG. 1.

As is depicted most clearly in FIG. 2, the forward strut assembly 30 supports rotation of the plurality of stages of fan blades 26A, 26B, 26C of the exemplary fan section 14. More particularly, the forward strut assembly 30 includes a plurality of struts 66 extending generally along the radial direction R, i.e., between an outer end 68 along the radial direction R and an inner end 70 along the radial direction R. The outer ends 68 of each of the plurality of struts 66 are attached to an outer structural case 72 of the forward strut assembly 30 and the inner ends 70 of each of the plurality of struts 66 are attached to an inner hub 74 of the forward strut assembly 30. The outer structural case 72 of the forward strut assembly 30 is configured for attachment to a frame or nacelle (not depicted) of the engine 10. Additionally, as is depicted, the outer structural case 72 includes an annular forward flange 73 at a forward end. Notably, the exemplary engine 10 depicted also includes a forward seal member 76 for forming a seal with the frame or nacelle of the engine 10.

Additionally, the inner hub 74 of the forward strut assembly 30 is attached to a bearing housing 78. For the embodiment depicted, the inner hub 74 is bolted to the bearing housing 78 through a plurality of bolts 80. The bearing housing 78 encloses a forward fan bearing 82 for supporting a rotor assembly 84 of the fan section 14. As discussed above, the rotor assembly 84 of the fan section 14 may be attached to, or may be an extension of, the LP shaft 56 of the engine 10. In certain embodiments, the forward fan bearing 82 may be configured as a ball bearing, a roller bearing, or any other suitable bearing.

Moreover, each of the plurality of struts 66 of the forward strut assembly 30 are configured with a guide vane 86. Each of the guide vanes 86 are positioned directly aft of a respective strut 66 and operable with a variable guide vane system 88. The variable guide vane system 88 is configured to rotate each of the plurality of guide vanes 86 about a guide vane axis 90, such that the plurality of guide vanes 86 may direct an airflow entering into the fan section 14 over the forward strut assembly 30 in a desired manner.

Referring now particularly to FIG. 3, the exemplary forward strut assembly 30 includes between thirteen (13) and twenty-one (21) struts 66 spaced along the circumferential direction C. Specifically for the embodiment depicted, the forward strut assembly 30 includes thirteen (13) struts 66. However, in other embodiments, the forward strut assembly 30 may instead include any other suitable number of struts 66. In certain embodiments, the plurality of struts 66 may be spaced substantially evenly along the circumferential direction C. However, in other embodiments, the plurality of struts 66 may be asymmetrically spaced along the circumferential direction C.

Further, as is depicted, the inner hub 74 of the forward strut assembly 30 defines a substantially circular shape with a substantially circular mounting surface 92. Additionally, each of the plurality of struts 66 includes an inner mounting bracket 94 at the inner ends 70, with each inner mounting bracket 94 including a curved mounting surface 96 matching a curve of the mounting surface 92 of the inner hub 74. Moreover, the outer structural case 72 of the forward strut assembly 30 includes a plurality of mounting pads 98 and a plurality of case ligaments 100. Each of the plurality of case ligaments 100 extends between adjacent mounting pads 98, connecting the adjacent mounting pads 98. For the embodiment depicted, the plurality of mounting pads 98 and case ligaments 100 are formed integrally of a composite material. For example, in certain embodiments, each of the plurality of mounting pads 98 and case ligaments 100 may be formed of a carbon fiber reinforced composite material. The carbon fiber reinforced composite material may include a plurality of arranged plies or layers, e.g., configured as a unidirectional tape, assembled around a frame. In other embodiments, the composite material may additionally, or alternatively include any other suitable composite material, such as a carbon or glass fiber reinforced composite material, or any suitable weave or braid of tape fiber architecture bonded using an epoxy or resin system (such as a bismalimide (BMI) or polyimide resin system). Additionally, the composite material may be used to form the plurality of mounting pads 98 and case ligaments 100 using a closed-mold strut tooling manufacturing process to provide a relatively high level of control of a final geometry of such components.

Further, the plurality of mounting pads 98 are spaced generally along the circumferential direction C, with each mounting pad 98 having a strut 66 of the plurality of struts 66 mounted thereto. Notably, for the embodiment depicted, the plurality of struts 66 each include an outer mounting flange 102 at the outer end of the respective strut 66. However, for the embodiment depicted, the mounting pads 98 of the outer structural case 72 extend in a substantially straight direction. Accordingly, the outer mounting flanges 102 of the plurality of struts 66 each include a straight mounting surface 104. Specifically, for the embodiment depicted, each of the outer mounting flanges 102 of the plurality of struts 66 are configured as a T-shaped flange.

Moreover, as is depicted, each of the plurality of case ligaments 100 extend in a substantially straight direction between adjacent mounting pads 98. It should be appreciated, that as used herein, the term “substantially straight” with reference to the plurality of case ligaments 100 refers to the particular case ligament 100 defining a radius of curvature greater than at least two times a radial length of one or more of the plurality of struts 66 of the forward strut assembly 30. Further, the term “substantially straight” may also refer to a case ligament 100 defining a straight neutral axis 118 (i.e., an axis through the ligament 100 where stress is zero; see FIG. 5) extending in a straight direction between the adjacent mounting pads 98 (between which the case ligament 100 extends).

Notably, as each of the plurality of mounting pads 98 also extend in a substantially straight direction (each defining a straight neutral axis 115 therethrough; see FIG. 5), each of the plurality of mounting pads 98 defines an angle with an adjacent case ligament 100 attached thereto. For the embodiment depicted, and as will be described in greater detail below, each of the angles defined between the mounting pads 98 and case ligaments 100 is less than one hundred and eighty degrees (180°) and within a ten percent (10%) margin of variation of each other (see FIG. 5).

Referring still to FIG. 3, each of the plurality of case ligaments 100 defines an inner surface 106 along the radial direction R. Given that each of the plurality of case ligaments 100 extend in a substantially straight direction between adjacent mounting pads 98, the radially inner surfaces 106 of the case ligaments 100 together define a non-circular shape as viewed along the axial direction A. As is discussed in greater detail below, in order to allow for the outer structural case 72 to define a flowpath surface 110 (i.e., a radially inner surface of the outer structural case 72 as a whole, defining a flowpath through the fan section 14) that more closely resembles a circle for aerodynamic purposes, the forward strut assembly 30 further includes a plurality of wedge members 112 positioned along the inner surfaces 106 of the case ligaments 100, adjacent to the mounting pads 98. For the embodiment depicted, each of the plurality of wedge members 112 extends less than fifty percent (50%) of a length of the case ligament 100 (i.e., a distance between adjacent mounting pads 98) adjacent to which it is positioned.

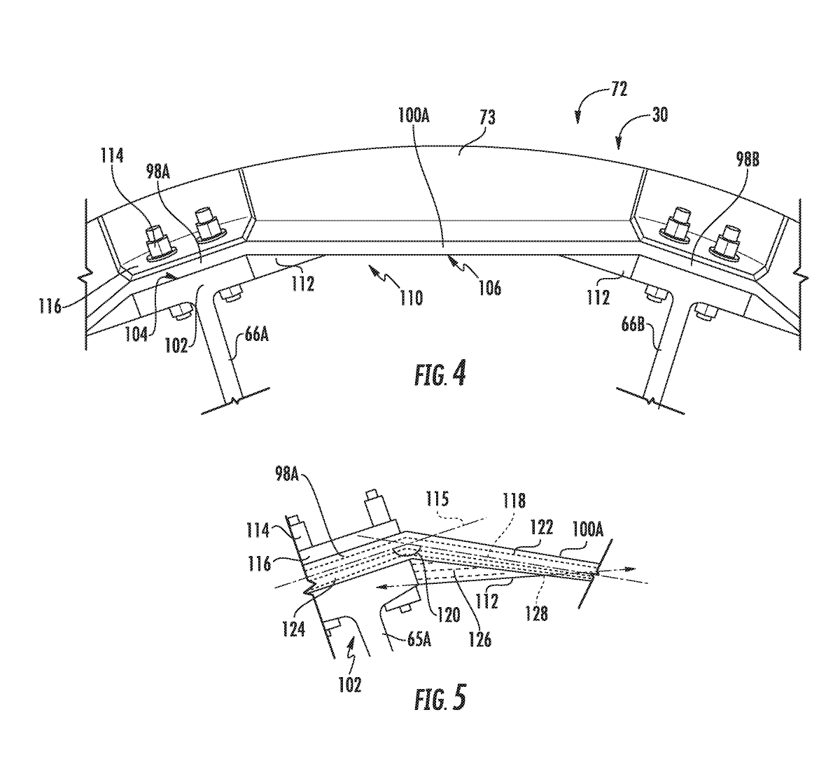

Referring now to FIGS. 4 and 5, close-up views of the forward strut assembly 30 of FIG. 3 are provided. More particularly, FIG. 4 depicts a close-up view of a first mounting pad 98A and a second mounting pad 98B, with a first case ligament 100A extending therebetween; and FIG. 5 provides a close-up view of the first mounting pad 98A and the first case ligament 100A. The first mounting pad 98A is configured for mounting a first strut 66A and the second mounting pad 98B is configured for mounting a second strut 66B. Specifically, the first and second struts 66A, 66B each include an outer mounting flange 102 (i.e., T-shaped flanges). The outer mounting flanges 102 are attached to the first and second mounting pads 98A, 98B through a plurality of fasteners, such as bolts and nuts 114, and mounting brackets 116. Specifically, the forward strut assembly 30 may include mounting brackets 116 positioned opposite the outer mounting flanges 102 for mounting the struts 66 to the respective mounting pads 98. The mounting brackets 116 may be separate from the mounting pads 98, or alternatively may be formed integrally with the mounting pads 98.

As was discussed above, the first case ligament 100A, first mounting pad 98A, and second mounting pad 98B each extend in substantially straight directions. Additionally, referring particularly to FIG. 5, the mounting pads 98A, 98B define a neutral axis 115 extending therethrough and, similarly, the first case ligament 100A defines a neutral axis 118 extending therethrough. The first mounting pad 98A defines an angle 120 with the first case ligament 100A, with the angle 120 being less than 180°. Notably, the second mounting pad 98B similarly defines an angle 120 with the first case ligament 100A (not labeled). The angles 120 defined by the first and second mounting pads 98A, 98B with the first case ligament 100A are substantially the same (i.e., within a 10% margin of variation, based on a circumferential spacing of the struts 66).

Further, the first and second mounting pads 98A, 98B are, for the embodiment depicted, formed integrally with the first case ligament 100A. Notably, as was also described above, the first mounting pad 98A, the second mounting pad 98B, and the first case ligament 100A are each formed of a continuous, structural composite material. As may be seen most clearly in FIG. 5, the composite material forming the first case ligament 100A includes a plurality of substantially aligned fibers 122. The plurality of substantially aligned fibers 122 extend parallel to the neutral axis 118, in a first direction from the first mounting pad 98A to the second mounting pad 98B. Notably, the composite material forming the first mounting pad 98A also includes a plurality of substantially aligned fibers 124, with the plurality of substantially aligned fibers 124 extending parallel to the neutral axis 115. It should be appreciated, that as used herein, the term “substantially aligned fibers” refers to a component including at least one ply having mostly all (i.e., at least about 75%) of the fibers extending in substantially the same direction. Moreover, as used herein, the term “substantially aligned fibers” does not exclude a component from including one or more “cross-plies”, or rather one or more plies with fibers extending generally in a direction perpendicular to the fibers of an adjacent ply to enhance various mechanical properties of the component.

Furthermore, the outer structural case 72 further includes the plurality of wedge members 112 positioned along the inner surfaces 106 of the case ligaments 100, including the first case ligament 100A. The plurality of wedge members 112 include wedge members 112 located adjacent to the first mounting pad 98A and adjacent to the second mounting pad 98B. Inclusion of the plurality of wedge members 112 may allow for the outer mounting flanges 102 of the plurality of struts 66 to be substantially recessed from a flowpath surface 110 of the fan section 14. Also, inclusion of the plurality of wedge members 112 may allow for the outer structural case 72 to more closely define a circular flowpath surface 110, despite utilization of substantially straight case ligaments 100.

Referring again particularly to FIG. 5, for the exemplary embodiment depicted the plurality of wedge members 112 are also formed of a composite material. However, the plurality of wedge members 112 are non-structural components, configured such that they do not influence a neutral axis 118 of the case ligaments 100 or a neutral axis 115 the mounting pads 98. For example, the plurality of wedge members 112 may be formed separately from the plurality of mounting pads 98 and case ligaments 100 and attached to the case ligaments 100 in any suitable manner. Further, the composite material forming the wedge members 112 may be the same as the composite material forming the mounting pads 98 and case ligaments 100, or alternatively, any other suitable composite material may be utilized. However, for the embodiment depicted, the composite material forming plurality of wedge members 112 also includes a plurality of substantially aligned fibers 126, with the substantially aligned fibers 126 extending in a second direction either parallel to reference line 128 or perpendicular to reference line 128 (i.e., extending along the axial direction of FIG. 2). As is depicted, the second direction (and the reference line 128) is not parallel to the first direction (or the neutral axis 118).

Inclusion of a strut assembly having an outer structural case formed of mounting pads and case ligaments extending in substantially straight directions may allow for the outer structural case to better withstand forces thereon during operation of the gas turbine engine. More specifically, inclusion of substantially straight case ligaments and substantially straight mounting pads may reduce a bending stress on the outer structural case, and may also improve a structural load carrying capability of the outer structural case, while improving weight efficiency. More specifically, still, a strut assembly including a case formed in accordance with one or more aspects of the present disclosure may allow for the case to better handle push and/or pull loads exerted on the case by the plurality of struts, through the mounting pads. For example, a strut assembly including a case formed in accordance with one or more aspects of the present disclosure may allow for the case to handle “punch” loads, such as various dynamic loads, exerted on the case by the plurality of struts.

Further, when forming the outer structural case of the strut assembly of a composite material, inclusion of substantially straight case ligaments and mounting pads may reduce an interlaminar stress on such components.

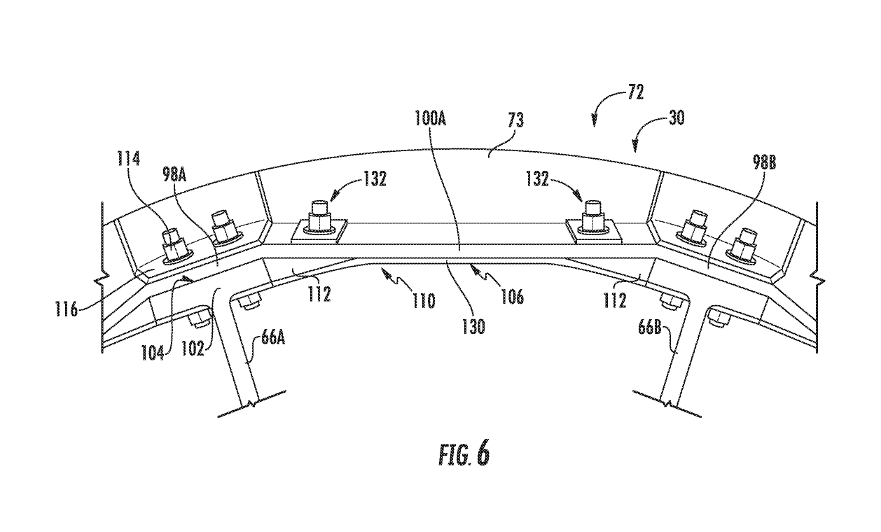

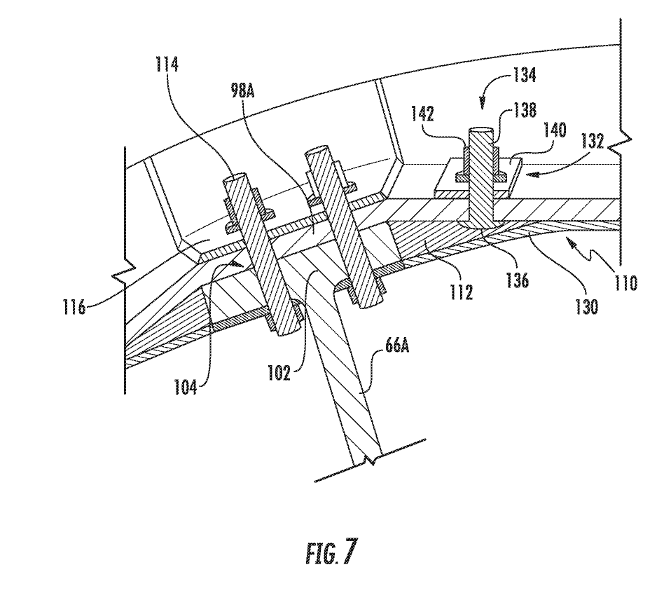

Referring now to FIGS. 6 and 7, close-up views of a forward strut assembly 30 in accordance with another exemplary embodiment of the present disclosure are provided. Specifically, FIG. 6 provides a close-up view of a first mounting pad 98A and a second mounting pad 98B, with a first case ligament 100A extending therebetween; and FIG. 7 provides a close-up, cross-sectional view of the first mounting pad 98A and the first case ligament 100A.

The exemplary forward strut assembly 30 may be configured in substantially the same manner as the exemplary strut assembly described above with reference to FIGS. 4 and 5. Accordingly the same numbers refer to the same or similar part. For example, the forward strut assembly 30 includes a first mounting pad 98A and a second mounting pad 98B, with a first case ligament 100A extending therebetween. Each of these components extends in a substantially straight direction and defines a substantially straight neutral axis.

However, for the embodiment depicted, the forward strut assembly 30 additionally includes a cover ply 130 of, e.g., a composite material, extending between adjacent struts 66 or continuously along the circumferential direction C, such that a smoother inner flowpath surface is defined. However, as with the embodiment described above, the plurality of wedge members 112 and cover ply/plies 130 are non-structural components so as to not influence or alter a neutral axis of the case ligaments 100 and/or mounting pads 98. Notably, by inclusion of a cover ply 130, the wedge members 112 may be formed of any suitable material capable of filling a void between the cover ply and case ligaments 100. For example, in certain exemplary embodiments, the wedge members 112 may be formed of a foam material, a honeycomb material, an injection molded plastic material, etc. For example, in certain exemplary embodiments, the wedge members 112 may be formed of a material having a Young's modulus (also known as tensile modulus) less than about one (1) million and/or having a density less than about five (5) pounds per cubic foot.

Moreover, for the exemplary embodiment depicted, the forward strut assembly 30 includes an attachment assembly 132 attached directly to at least one of the case ligament 100 or mounting pad 98. Specifically, for the embodiment depicted, the forward strut assembly 30 includes an attachment assembly 132 attached directly to the first case ligament 100A. The attachment assembly 132 generally includes a bolt 134 having a body 136 and a head 138, with the head 138 positioned on an inside surface of the case ligament 100 and configured, for the embodiment depicted, as a stud grommet. The attachment assembly 130 additionally includes a plate 140 and a nut 142. The body 136 of the bolt 134 extends through the case ligament 100 and plate 140 and includes a threaded portion that engages with the nut 142. The plate 140 may be a portion of an engine component, or alternatively, may be a mounting plate for mounting the forward strut assembly 30.

Further, it should be noted that the head 138 of the bolt 134 is positioned adjacent to (and contacts) the wedge member 112, which may be, e.g., a foam material, covered by the cover ply 130. Such a configuration may provide for an additional level of security, as the wedge member 112 and cover ply 130 may prevent the bolt 134 from entering the core air flowpath in the event that the nut 142 detaches. Accordingly, inclusion of a wedge member 112 and cover ply 130 may allow for mounting one or more components through an attachment assembly 132 to one or more case ligaments 100 of the forward case assembly 30 more safely.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A strut assembly for a gas turbine engine, the strut assembly comprising:
an outer structural case comprising
a first mounting pad for mounting a first strut;
a second mounting pad for mounting a second strut; and
a case ligament extending between the first mounting pad and the second mounting pad, the case ligament extending in a substantially straight direction from the first mounting pad to the second mounting pad.

2. The strut assembly of claim 1, wherein the first mounting pad, the second mounting pad, and the case ligament are each formed of a composite material.

3. The strut assembly of claim 1, wherein the case ligament is formed of a composite material, wherein the composite material forming the case ligament includes a plurality of substantially aligned fibers.

4. The strut assembly of claim 3, wherein the plurality of substantially aligned fibers extend in a direction from the first mounting pad to the second mounting pad.

5. The strut assembly of claim 1, wherein the case ligament defines an inside surface, wherein the outer structural case further comprises a plurality of wedge members positioned along the inside surface of the case ligament adjacent to the first mounting pad and adjacent to the second mounting pad.

6. The strut assembly of claim 5, wherein the plurality of wedge members are non-structural components.

7. The strut assembly of claim 6, wherein the plurality of wedge members are formed of a composite material, wherein the case ligament is formed of a composite material, wherein the composite material forming the case ligament includes a plurality of substantially aligned fibers extending in a first direction, wherein the composite material forming the wedge members includes a plurality of substantially aligned fibers extending in a second direction, and wherein the first direction is not parallel to the second direction.

8. The strut assembly of claim 6, wherein the wedge members are formed of a foam material.

9. The strut assembly of claim 6, further comprising:
an attachment assembly including a bolt having a head and a body, wherein the body extends through the case ligament and wherein the head is positioned adjacent to the wedge member.

10. The strut assembly of claim 1, wherein the first mounting pad extends in a substantially straight direction, wherein the second mounting pad extends in a substantially straight direction, wherein the first mounting pad defines a first angle with the case ligament, wherein the second mounting pad defines a second angle with the case ligament, wherein the first and second angles are less than 180 degrees.

11. The strut assembly of claim 10, wherein the first angle is substantially equal to the second angle.

12. The strut assembly of claim 1, wherein the first and second mounting pads are formed integrally with the case ligament.

13. A strut assembly for a gas turbine engine defining a circumferential direction, the strut assembly comprising:
a plurality of struts; and
an outer structural case comprising
a plurality of mounting pads spaced generally along the circumferential direction, each mounting pad having a strut of the plurality of struts mounted thereto; and
a plurality of case ligaments extending between adjacent mounting pads, each case ligament extending in a substantially straight direction between adjacent mounting pads.

14. The strut assembly of claim 13, wherein the outer structural case is formed of a composite material.

15. The strut assembly of claim 13, wherein the plurality of case ligaments are formed of a composite material, wherein the composite material forming the case ligaments includes a plurality of substantially aligned fibers.

16. The strut assembly of claim 13, wherein the case ligaments each define an inside surface, wherein the outer structural case further comprises a plurality of wedge members positioned along the inside surfaces of the case ligaments adjacent to the mounting pads.

17. The strut assembly of claim 13, wherein the plurality of struts each include a T-shaped flange, wherein the plurality of struts are attached to the plurality of mounting pads using the T-shaped flanges.

18. The strut assembly of claim 13, wherein each of the mounting pads extend in a substantially straight direction, wherein each of the mounting pads define an angle with the case ligaments adjacent to the mounting pad, wherein each of the angles defined between the mounting pads and the case ligaments are substantially the same.

19. The strut assembly of claim 13, wherein the plurality of struts includes between thirteen and twenty-one struts.

20. A gas turbine engine comprising:
a core turbine engine; and
a fan section in flow communication with the core turbine engine, the fan section comprising a strut assembly having an outer structural case, the outer structural case comprising
a first mounting pad for mounting a first strut;
a second mounting pad for mounting a second strut; and
a case ligament extending between the first mounting pad and the second mounting pad, the case ligament extending in a substantially straight direction from the first mounting pad to the second mounting pad.

21. The gas turbine engine of claim 20, wherein the case ligament is formed of a composite material, wherein the composite material forming the case ligament includes a plurality of substantially aligned fibers extending in a direction from the first mounting pad to the second mounting pad.

22. The gas turbine engine of claim 20, wherein the strut assembly is a forward strut assembly of the fan section.
